(19) United States
(12) Patent Application Publication
(10) Pub. No.: US 2013/0027913 A1
(43) Pub. Date: Jan. 31, 2013

(54) MAKEUP MIRROR WITH LIGHT SOURCE

(71) Applicants: David Frisch, Dongguan City (CN); Kelly O'Brien Martelli, Tampa, FL (US); Kelly Shea Kuethe, Lutz, FL (US)

(72) Inventors: David Frisch, Dongguan City (CN); Kelly O'Brien Martelli, Tampa, FL (US); Kelly Shea Kuethe, Lutz, FL (US)

(73) Assignee: OTTLITE TECHNOLOGIES, INC., Tampa, FL (US)

(21) Appl. No.: 13/194,416

(22) Filed: Jul. 29, 2011

(51) Int. Cl. F21V 33/00

(52) U.S. Cl. 362/141; 362/140

(57) ABSTRACT

A makeup mirror having a light source configured to have output that not only enhances the visibility of objects as they are reflected by the mirror, but also optimizes visual acuity of the reflected image as captured by the human eye. In some cases, the makeup mirror allows for separate adjustment of the mirror and the light source, which, in combination with the light source, enables the reflected objects to be lit in uniform manner and for optimized human visual acuity while allowing for areas of the objects to be examined in detail as desired.

### FIELD OF THE INVENTION

The present invention relates to makeup mirrors, and more particularly, to makeup mirrors with light source(s) provided in their assemblies.

### BACKGROUND

Historically, makeup mirror designs have come in a wide variety of shapes and sizes. Their designs generally include a body that supports one or more mirrors. In designs having more than one mirror, the mirrors generally are found to have differing reflective properties, whereby one of the mirrors provides a reflection of objects that is equal to the actual sizes of such objects, while another of the mirrors provide a reflection of objects that is greater than the actual sizes of such objects. As such, these makeup mirrors are advantageous, for example, in being able to project one's face in its entirety as well as being able to project enlarged areas of one's face for detailed examination.

In makeup mirror designs involving dual mirrors, it is common to have these mirrors on opposing planar sides of the body. For example, in certain designs, the body is operatively coupled to a stand, and adjustable in relation to the stand so as to have either mirror oriented toward a person as desired. As such, the body can be set in a first position at which the mirror having actual-image projection is oriented toward a person, and then the body can be adjusted to a second position at which the mirror having enhanced-image projection is oriented toward the person. While such makeup mirrors are typically designed for being used in examining the features of one's face, the mirrors can just as well be used in facilitating detailed examination of other regions of the body.

In some makeup mirror designs, one or more light sources are incorporated therein. The general purpose of equipping the makeup mirrors with such light sources has been to provide enhanced visibility with respect to objects, e.g., one or more of the user's facial features, which are reflected in the mirrors. However, to not detract from the aesthetic nature of the makeup mirror, the light sources have generally been confined to smaller sizes. Consequently, some popular light sources used to date in makeup mirror designs have involved smaller-sized incandescent lamps and compact fluorescent lamps (CFLs).

As described above, much focus has been placed on incorporating a light source in makeup mirrors so as to enhance facial features reflected by the mirror, while also not detracting from the design's aesthetic appearance. To that end, the light sources used to date (e.g., smaller-sized incandescent lamps and CFLs) have generally been viewed as being successful in achieving both goals. However, in actual application, an overabundance of bright light is routinely attained from these light sources. Consequently, not only can painful glare result (putting strain on the eye), but the human eye's ability to see with clarity, efficiency, and focus can be compromised. As a result, in attempting to enhance the visibility of what the mirror reflects, designers to date have been found to generally select light sources having outputs that can impair visual acuity. Reasons for making this selection can be attributed to many causes, with cost likely being one of the biggest; however, ignorance of such inconsistency could be just as likely. Neither reason, however, is excusable, particularly in a product where visual acuity is so closely tied to its intended use.

### SUMMARY OF THE INVENTION

Embodiments of the present invention involve a makeup mirror having a light source configured to have output that not only enhances the visibility of objects as they are reflected by the mirror, but also optimizes visual acuity of the reflected image as captured by the human eye. In some cases, the makeup mirror allows for separate adjustment of the mirror and the light source, which, in combination with the light source, enables the reflected objects to be lit in uniform manner and for optimized human visual acuity while allowing for areas of the objects to be examined in detail as desired.

### DESCRIPTION OF THE DRAWINGS

FIG. 1 is a front perspective view of a makeup mirror in accordance with certain embodiments of the invention.

FIG. 2 is a rear perspective view of the makeup mirror of FIG. 1.

### DETAILED DESCRIPTION

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

As described above, the makeup mirror as embodied herein is formed of a body that is operatively coupled to one or more mirrors. The body also supports one or more light sources configured to emit light on objects positioned in front of the makeup mirror, and as such, reflected by the mirror. As is further detailed below, the light sources are configured to have output that not only enhances the visibility of such objects as they are reflected by the mirror, but also optimizes visual acuity (e.g., promoting clarity, efficiency, and focus) of the reflected image as captured by the human eye. In some cases, as further described, the makeup mirror has two mechanisms for adjustment, a first mechanism with regard to adjusting the body as a whole, and a second mechanism with regard to adjusting the mirror. Providing such dual adjustment mechanisms, in combination with the light sources alluded to above (and further detailed below), enable the reflected object to be lit in uniform manner and for optimized human visual acuity while allowing for areas of the object to be examined in detail as desired.

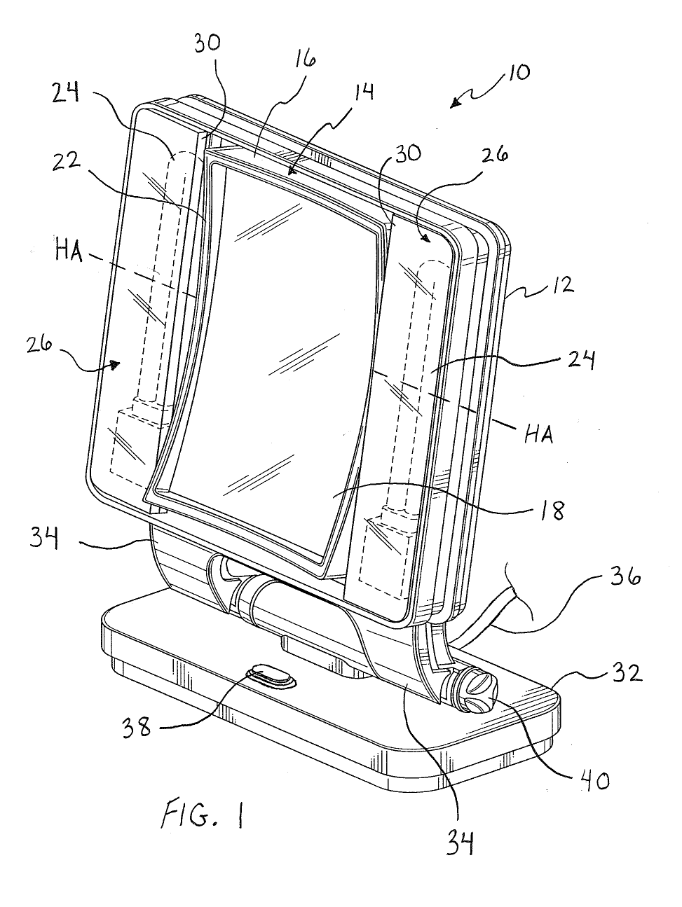

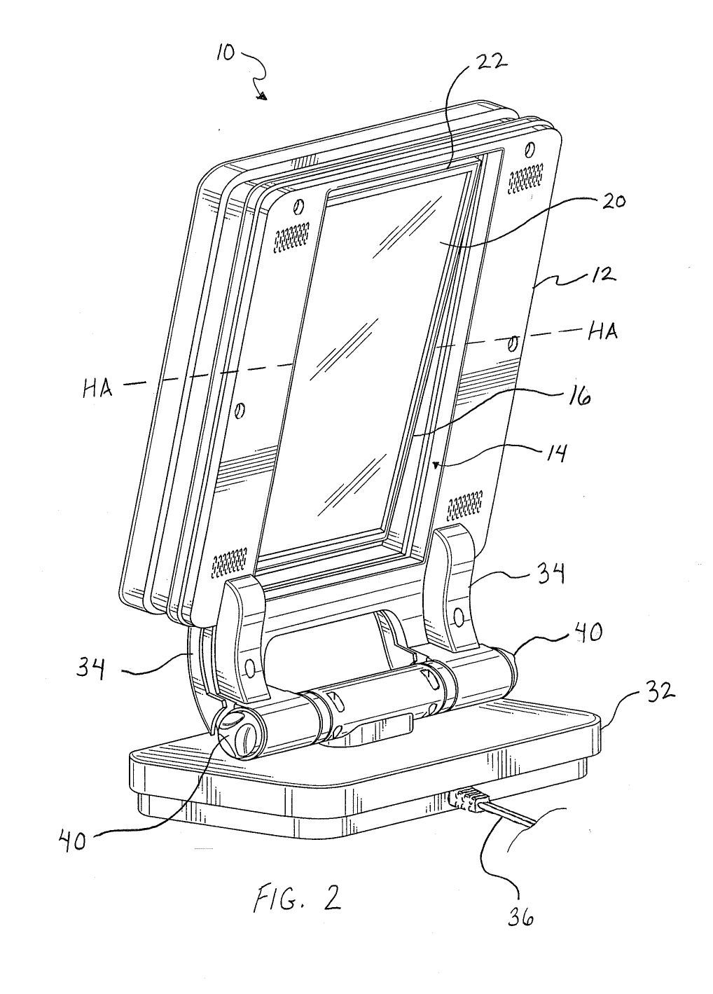

FIG. 1 illustrates a front perspective view of a makeup mirror in accordance with certain embodiments of the invention, while FIG. 2 shows a rear perspective view of the mirror. As shown, the makeup mirror 10 includes a body 12 operatively coupled to a mirror assembly 14. In certain embodiments, as shown with reference to FIG. 2, the mirror assembly 14 includes a frame 16 that retains a first mirror 18 and a second mirror 20. As shown, in certain embodiments, the first and second mirrors 18, 20 are operatively coupled to the frame 16. As should be appreciated, various manners of coupling the mirrors 18, 20 to the frame 14 can be used. To that end, in certain embodiments, as exemplified in FIG. 1 with regard to the first mirror 18, the planar surfaces of the mirrors can be recessed with respect to corresponding outer edges 22 of the frame 16. Alternatively, in certain embodiments, as exemplified in FIG. 2 with regard to the second mirror 20, the planar surfaces of the mirrors can substantially aligned with such frame outer edges 22.

In certain embodiments, as shown, the first and second mirrors 18, 20 are oppositely oriented from each other, with the frame 16 being adjustable in relation to the body 12. In certain embodiments, the frame 16 is rotatably adjustable in relation to the body 14. Such adjustable rotation, in certain embodiments, can be facilitated via the same means for operatively coupling the frame 16 to the body 14. For example, while not visibly shown, a through rod could be used, passing through a central axis of the frame 14 and between the mirrors 18, 20, with the rod having one threaded end and a non-threaded end correspondingly joined with opposing threaded and non-threaded apertures in the body 14. As should be appreciated from the makeup mirror 10 of the figures, the frame 16 has a horizontal axis HA of rotation; however, it should be appreciated that the frame 16 can just as well have a vertical axis of rotation. As such, the through rod (exemplified above) would extend along the horizontal axis HA. In using a threaded coupling on one end of the rod, such mating threads would provide friction so as enable the frame 16 to be held in the rotated position.

By configuring the frame 16 to be adjustable to the body 14, it should follow that the mirrors 18, 20 are to be used at separate times by the user, whereby either the first mirror 18 or second mirror 20 is oriented toward the object (e.g., person's face) as desired. In certain embodiments, the mirrors 18, 20 have differing reflective properties. For example, the first mirror 18 can be configured to provide a reflection of objects that is equal to (or 100%) the actual sizes of such objects, while the second mirror 20 can be configured to provide a reflection of objects that is greater than (e.g., two or three times) the actual sizes of such objects. Thus, when used in examining one's face, the first mirror 18 can be oriented toward a person in examining the features of the face in its entirety, while the second mirror 20 can be oriented toward the person in enabling detailed examination of certain facial features.

As shown, the body 14 further includes one or more light sources 24. In certain embodiments, the body defines one or more recesses 26 to correspondingly receive the one or more light sources 24. As further shown, in certain embodiments, the recesses 26 are positioned to flank the frame 16 (and thereby the mirrors 18, 20) of the body 14. Consequently, the light sources 24 can be positioned proximate to (e.g., to flank opposing sides of) the mirrors 18, 20 so as to effectively emit light on a person's face while not interfering with in-line sight of the mirrors 18, 20. The recesses 26, in certain embodiments, include corresponding structure for directing or protecting the light sources 24. For example, while not visibly shown, the structure can involve a reflector positioned in the recess 26 rearward of the light source 24 to direct a maximum amount of the emitted light toward the person's face. Additionally, in certain embodiments, the structure can involve a cover 30. In certain embodiments, the cover 30 is formed of a translucent material that permits transmission of the light emitted by the light source 24, while also providing frontal protective structure for the source 24.

The light sources 24, as alluded to above, are configured to have output that not only enhances the visibility of the person's face as it is reflected by the mirror, but also is adapted to promote clarity, efficiency, and focus of the reflected image as captured by the human eye. Historically, the output of artificial lighting has been measured more for photopic content of the light while generally ignoring the effect of the scotopic content. For example, in the instant case involving makeup mirrors, the focus has conventionally involved incorporating a light source such that its output enhances facial features reflected by the mirror (and to some extent, not detracting from the design's aesthetic appearance) without much emphasis on how the human eye perceives such output. As described above, such lack of focus on how the human eye perceives the output has resulted in compromising the eye's visual acuity (e.g., involving clarity, efficiency, and focus).

Research has demonstrated that by fine tuning the light spectrum, light levels can be reduced without compromising visual acuity and color response. In particular, due to the physiological aspects of the eye, it is possible to decrease light levels without reducing performance by controlling the spectral distribution of artificial lighting. As such and as further detailed below, energy savings can be achieved by relative efficacy of light production (lumens) of spectrally modified lamps.

In particular, the retina of the eye has both rod and cone receptors. The rods operate at low light levels, the cones operate at high light levels, and both operate over a range at intermediate light levels. Rods (night vision) do not provide color response or high visual acuity. On the other hand, cones provide color vision and the acuity necessary for reading and seeing small detail. Photopic lumens are based on cone sensitivity, while scotopic lumens are based on rod sensitivity. In photopic conditions, wavelengths near 550 nanometers appear to be brighter than those near 500 nanometers. The reverse is true in scotopic conditions where wavelengths near 500 nanometers are brighter than those near 550 nanometers. For example during the day, yellow objects appear lighter, but as the sun goes down and the scotopic comes into play green objects appear lighter. At dusk, illumination is low enough for the scotopic effect to operate, but still high enough for the photopic to also operate. Since cones and rods both contribute to visual acuity S/P (scotopic/photopic ratios) are a useful tool in analyzing the effectiveness of a light source on visual acuity.

As shown in FIG. 1, in certain embodiments, the light source 24 of the makeup mirror 10 is a fluorescent lamp, and more preferably, a compact fluorescent lamp (CFL); however, it should be appreciated that other lamp sources (e.g., other than fluorescent lamps) are applicable to the embodiments of the invention so long as they emit light in the optimized wavelength range. In certain embodiments, the light source 24 is adapted to emit light at a wavelength in the range of between about 505 nanometers and about 515 nanometers, and perhaps more preferably, at a wavelength of about 508 nanometers, a wavelength optimized for human visual acuity. In particular, at this wavelength, the amount of scotopic lumens that affects the rod receptors in the eye is maximized. To that end, the light emitted at this wavelength causes the pupils of the eye to contract without the presence of painful glare and an overabundance of bright light, thereby enabling the human eye to see with greater clarity, efficiency and better focus. Moreover, this optimal efficiency of the human eye generated by the high scotopic lumens, is produced in an environment of lower photopic lumens, which normally is construed as lower ambient light. As such, the light source 24 generally uses less electrical energy than conventional lighting sources having comparable outputs.

The light source 24 can be formed using a variety of differing processes. One such process is detailed in U.S. Patent Publication No. US2005/0104040, the teachings of which are incorporated herein by reference, and involves configuration of a fluorescent lamp. As described therein, the fluorescent lamp can be formed via the use of a plurality of phosphors, which when emulsified and used to coat the inside of a fluorescent lamp, emit light at a wavelength from about 505 nanometers to about 515 nanometers. In one case, the phosphors can consist of strontium boride, yttrium oxide, barium yttrium oxide, europium, terbium, barium borate and calcium.

In use, such design of the light source 24 enhances effective pupil lumens for improved human visual acuity (known to be a function of both scotopic and photopic lumens). As described above, such visual acuity is optimized at a light wavelength in the range of about 505 nanometers to about 515 nanometers. As alluded to above, the combination of scientific knowledge surrounding visual acuity, e.g., with fluorescent technology, to produce a light emitter that helps people to see as well as the human eye can see, has not gained much traction in the lighting industry. However, in an application where visual acuity is so closely tied to the intended usefulness of the product, such as with makeup mirrors, the use therein of a light source 24 that emits light in the range of about 505 nanometers to about 515 nanometers optimizes the design.

Returning to the figures, in certain embodiments, as shown, the body 14 is operatively coupled to a stand 32. To that end, the stand 32 can have one or more linking members 34 which couple the stand 32 to the body 14. The light source 24 can be powered as is generally known in the art. For example, incoming voltage is provided through a power cord 36 (e.g., fed into the rear side of the stand 32). As such, electrical wiring extends from the power cord 36 through the stand and up to the light source 24. In certain embodiments, as shown, the makeup mirror 10 includes a power switch 38 to permit voltage from the power cord 36 to be selectively extended to or removed from the light source 24.

In certain embodiments, the one or more linking members 34 of the stand 32 enable adjustment of the body 14 (and the frame 16 and its mirrors 18, 20) with regard to the stand 32, with a locking mechanism to retain the body 14 in any adjusted position relative to the stand 32. In certain embodiments, as shown, the locking mechanism can involve locking members 40 threadably received by the linking members 34 for locking the body 14 in position. In providing separate adjustability with regard to the body 14 and the frame 16, and combining such features with the fluorescent lamp as described above for the light source 24, the reflected object can be lit in uniform manner and for optimized human visual acuity while also allowing for areas of the object to be further examined in detail as desired.

By way of comparison, conventional makeup mirrors incorporated with lighting sources often are limited to simultaneous adjustment of the mirrors and light sources. However, with such designs, as the mirror is shifted to project various areas of the face, shadows result in the reflected image, which can detract from or impair the reflected image. Further, in makeup mirror designs having separate adjustment for the mirrors and the light sources, abundance of bright light emitted from the light source does not allow the benefits of such adjustability to be fully realized.

It will be appreciated the embodiments of the present invention can take many forms. The true essence and spirit of these embodiments of the invention are defined in the appended claims, and it is not intended the embodiment of the invention presented herein should limit the scope thereof.

What is claimed is:

1. A makeup mirror comprising a body operatively coupled to one or more mirrors, the body including one or more fluorescent lamps positioned proximate to the one or more mirrors, the one or more fluorescent lamps configured to have output that enhances visibility of objects as reflected by the one or more mirrors and optimizes visual acuity of the reflection as captured by a human eye, the one or more fluorescent lamps when powered emitting light in a wavelength range of about 505 nanometers to about 515 nanometers.

2. The makeup mirror of claim 1 wherein the output of the one or more fluorescent lamps comprise scotopic lumens and photopic lumens, the output comprising a higher quantity of scotopic lumens than photopic lumens at the wavelength range.

3. The makeup mirror of claim 2 wherein the one or more fluorescent lamps are configured to use less energy than other lighting sources having comparable output.

4. The makeup mirror of claim 1 wherein the optimized visual acuity comprises promotion of clarity, efficiency, and focus of the reflection as captured by a human eye.

5. The makeup mirror of claim 1 wherein the one or more mirrors are part of a mirror assembly that further includes a frame, wherein the one or more mirrors are operatively coupled to the frame and the frame is adjustable relative to the body.

6. The makeup mirror of claim 5 wherein the one or more mirrors comprise first and second mirrors, the first and second mirrors having differing reflective properties and oppositely oriented from each other.

7. The makeup mirror of claim 5 further comprising a stand, wherein the body is operatively coupled to and adjustable relative to the stand.

8. The makeup mirror of claim 7 wherein the stand includes a locking mechanism to retain the body in any adjusted position relative to the stand.

9. The makeup mirror of claim 1 wherein the one or more fluorescent lamps comprise first and second fluorescent lamps, the first and second lamps each positioned so as to flank opposing sides of the one or more mirrors so as to effectively emit light on a person's face while not interfering with in-line sight of the one or more mirrors.

10. A makeup mirror comprising a body operatively coupled to a mirror assembly, the mirror assembly including one or more mirrors operatively coupled to a frame, the frame adjustably coupled to the body, the body including one or more light sources positioned proximate to the one or more mirrors, the body being operatively coupled and adjustable relative to a stand, the one or more light sources when powered emitting light in a wavelength range of about 505 nanometers to about 515 nanometers, the adjustment of the body enabling the one or more light sources to light objects to be reflected in uniform manner and for optimized visual acuity while the adjustment of the frame enables further detailed examination of areas of the objects.

11. The makeup mirror of claim 10 wherein output of the one or more light sources comprise scotopic lumens and photopic lumens, the output comprising a higher quantity of scotopic lumens than photopic lumens at the wavelength range.

12. The makeup mirror of claim 11 wherein the one or more light sources are configured to use less energy than other lighting sources having comparable output.

13. The makeup mirror of claim 10 wherein the optimized visual acuity comprises promotion of clarity, efficiency, and focus of the reflection as captured by a human eye.

14. The makeup mirror of claim 10 wherein the one or more light sources are fluorescent lamps.

15. The makeup mirror of claim 10 wherein the one or more mirrors comprise first and second mirrors, the first and second mirrors having differing reflective properties and oppositely oriented from each other.

16. The makeup mirror of claim 10 wherein the one or more lights sources comprise first and second light sources, the first and second light sources each positioned so as to flank opposing sides of the one or more mirrors so as to effectively emit light on a person's face while not interfering with in-line sight of the one or more mirrors.

17. A makeup mirror comprising a body operatively coupled to one or more mirrors, the one or more mirrors adjustable relative to the body, the body including one or more light sources positioned proximate to the one or more mirrors, the body being operatively coupled and adjustable relative to a stand, the one or more light sources when powered emitting light in a wavelength range of about 505 nanometers to about 515 nanometers, the adjustment of the body enabling the one or more light sources to light objects to be reflected in uniform manner and for optimized visual acuity while the adjustment of the one or more mirrors enables further detailed examination of areas of the objects.

18. The makeup mirror of claim 17 wherein the optimized visual acuity comprises promotion of clarity, efficiency, and focus of the reflection as captured by a human eye.

19. The makeup mirror of claim 17 wherein the one or more light sources are fluorescent lamps.

20. The makeup mirror of claim 17 wherein the one or more lights sources comprise first and second light sources, the first and second light sources each positioned so as to flank opposing sides of the one or more mirrors so as to effectively emit light on a person's face while not interfering with in-line sight of the one or more mirrors.
